(19) United States
(12) Patent Application Publication
(10) Pub. No.: US 2013/0245985 A1
(43) Pub. Date: Sep. 19, 2013

(54) Calibration Of An Optical Metrology System For Critical Dimension Application Matching

(71) Applicant: KLA-TENCOR CORPORATION, Milpitas, CA (US)

(72) Inventors: Klaus Flock, Sunnyvale, CA (US); Lawrence Rotter, Pleasanton, CA (US); Muzammil Arain, Milpitas, CA (US)

(73) Assignee: KLA-TENCOR CORPORATION, Milpitas, CA (US)

(21) Appl. No.: 13/794,337

(22) Filed: Mar. 11, 2013

Related U.S. Application Data
(60) Provisional application No. 61/610,626, filed on Mar. 14, 2012.

(51) Int. Cl. G05B 23/00

(52) U.S. Cl. CPC G05B 23/00
USPC 702/105

(57) ABSTRACT

Methods and systems for matching critical dimension measurement applications at high precision across multiple optical metrology systems are presented. In one aspect, machine parameter values of a metrology system are calibrated based on critical dimension measurement data. In one further aspect, calibration of the machine parameter values is based on critical dimension measurement data collected by a target measurement system from a specimen with assigned critical dimension parameter values obtained from a reference measurement source. In another further aspect, the calibration of the machine parameter values of a target measurement system is based on measurement data without knowledge of critical dimension parameter values. In some examples, the measurement data includes critical dimension measurement data and thin film measurement data. Calibration of machine parameter values based on critical dimension data enhances application and tool-to-tool matching among systems for measurement of critical dimensions, film thickness, film composition, and overlay.

### CROSS REFERENCE TO RELATED APPLICATION

The present application for patent claims priority under 35 U.S.C. §119 from U.S. provisional patent application Ser. No. 61/610,626, entitled “Calibration Of An Optical Metrology System For CD/Application Matching,” filed Mar. 14, 2012, the subject matter of which is incorporated herein by reference in its entirety.

### TECHNICAL FIELD

The described embodiments relate to optical metrology systems and methods, and more particularly to methods and systems for improved consistency across critical dimension measurement applications.

### BACKGROUND INFORMATION

Semiconductor devices such as logic and memory devices are typically fabricated by a sequence of processing steps applied to a specimen. The various features and multiple structural levels of the semiconductor devices are formed by these processing steps. For example, lithography among others is one semiconductor fabrication process that involves generating a pattern on a semiconductor wafer. Additional examples of semiconductor fabrication processes include, but are not limited to, chemical-mechanical polishing, etch, deposition, and ion implantation. Multiple semiconductor devices may be fabricated on a single semiconductor wafer and then separated into individual semiconductor devices.

Optical metrology processes are used at various steps during a semiconductor manufacturing process to detect defects on wafers to promote higher yield. Optical metrology techniques offer the potential for high throughput without the risk of sample destruction. A number of optical metrology based techniques including scatterometry and reflectometry implementations and associated analysis algorithms are commonly used to characterize critical dimensions, film thicknesses, composition and other parameters of nanoscale structures.

As devices (e.g., logic and memory devices) move toward smaller nanometer-scale dimensions, characterization becomes more difficult. Devices incorporating complex three-dimensional geometry and materials with diverse physical properties contribute to characterization difficulty. In addition to accurate device characterization, measurement consistency across a range of measurement applications and a fleet of inspection systems tasked with the same measurement objective is also important. If measurement consistency degrades in a manufacturing environment, consistency among processed semiconductor wafers is lost and yield drops to unacceptable levels. Matching measurement results across applications and across multiple systems ensures that measurement results on the same wafer for the same application yield the same result. A calibration process that ensures repeatable measurement results among a fleet of tools is sometimes referred to as tool-to-tool matching.

A typical calibration approach for model based measurement systems consists of measuring a number of film/substrate systems of known thickness and dielectric function. A regression is performed on machine parameters until the combination of parameters returns the expected values for thickness and/or dielectric function. In one example, a set of film wafers having a silicon dioxide layer on crystalline silicon over a range of thicknesses is measured and a regression is performed on the machine parameters until the machine returns the best match for thickness and/or refraction index for the given set of films. Other examples are described in U.S. Pat. Pub. No. 2004/0073398 entitled, “Methods and Systems for Determining a Critical Dimension and a Thin Film Characteristic of a Specimen,” which is incorporated by reference as if fully set forth herein. This calibration procedure may be applied across a fleet of measurement systems using the same set of wafers. These wafers are sometimes referred to as transfer standards.

Machine parameters are often calibrated based on thin film measurements because thin film systems (e.g., silicon dioxide on crystalline silicon) can be manufactured with well known optical constants, clean interfaces, and low surface roughness that enable measurement of wafer characteristics with a degree of repeatability near the sensitivity of the measurement systems being calibrated. After calibration to a set of transfer standards, a fleet of measurement systems deliver consistent measurement results for thin film measurements. However, in addition, measurement systems calibrated based on thin film measurements are often used to measure critical dimension (CD) applications. Thus, current methods of tool-to-tool matching do not differentiate between films and CD applications. However, when a system calibrated based on film measurements is used to measure CD applications, a matching performance is worse than one would expect for a film measurement application and an order of magnitude worse than the sensitivity of modern CD measurement systems.

Tool-to-tool matching is a core challenge in the development of an optical metrology system that meets customer requirements of the semi-conductor industry. Process and yield control in both the research and development and manufacturing environments demands tool-to-tool consistency of measurement results on the order of the repeatability of the CD parameter values. Existing calibration approaches have failed to meet these demands. Thus, methods and systems for improved tool-to-tool matching for CD measurements are desired.

### SUMMARY

Methods and systems for matching critical dimension measurements at high precision from multiple optical metrology systems are presented. Such systems are employed to measure structural and material characteristics (e.g., material composition, dimensional characteristics of structures and films, etc.) associated with different semiconductor fabrication processes. In one aspect, machine parameter values of a metrology system are calibrated based on critical dimension measurement data. In some examples, the system is calibrated to a reference measurement source within less than one percent of each value of each critical dimension measurement application. By way of non-limiting example, calibration of machine parameter values based on critical dimension data may be employed to enhance application and tool-to-tool matching among systems for measurement of critical dimensions (CD), film thickness, film composition, and overlay.

In one further aspect, the calibration of the machine parameter values is based on critical dimension measurement data collected by a target measurement system from a specimen with assigned critical dimension parameter values. The critical dimension parameter values are obtained from a reference measurement source. In some examples, the reference measurement source is a similar tool that is treated as a reference tool (or “golden” tool). Measurements from a “golden” tool are treated as the desired measurement output for a particular sample. The objective is to calibrate the machine parameter values of the target measurement system such that the critical dimension measurement output of the target measurement system matches the measurement output of the “golden” tool for the particular set of CD parameters. In this manner, the target measurement system is “matched” with the “golden” tool for that set of CD parameters. The calibration is repeated for other similar target measurement systems such that an entire fleet of similar measurement systems are “matched” to the “golden” tool.

In some other examples, the reference measurement source is an average measurement output of a fleet of similar tools. The average measurement output of the fleet of tools for a particular sample is treated as the desired measurement output. The objective is to calibrate the machine parameter values of the target measurement system such that the measurement output of the target measurement system matches the average measurement output of the fleet of tools. In this manner, the target measurement system is “matched” with the fleet average. The calibration is repeated for other similar target measurement systems such that the each of the fleet of similar measurement systems is “matched” to the fleet average.

In another further aspect, the calibration of the machine parameter values of a target measurement system is based on measurement data from one or more measurement systems without knowledge of critical dimension parameter values. In some examples, the measurement data includes measurement data from a thin film specimen and measurement data from a CD specimen. In some examples, the calibration of the machine parameter values is based on measurement data from a single measurement system. In some examples, the calibration of the machine parameter values is based on measurement data from multiple measurement systems.

The foregoing is a summary and thus contains, by necessity, simplifications, generalizations and omissions of detail; consequently, those skilled in the art will appreciate that the summary is illustrative only and is not limiting in any way. Other aspects, inventive features, and advantages of the devices and/or processes described herein will become apparent in the non-limiting detailed description set forth herein.

### BRIEF DESCRIPTION OF THE DRAWINGS

FIG. 1 is a diagram illustrative of a metrology system 100 configured to implement the calibration methods described herein.

FIG. 2 is a flowchart illustrative of an exemplary method 200 of calibrating machine parameter values of a metrology system based on CD measurements.

### DETAILED DESCRIPTION

Reference will now be made in detail to background examples and some embodiments of the invention, examples of which are illustrated in the accompanying drawings.

Methods and systems for matching critical dimension measurement applications across one or more optical metrology systems are presented. Such systems are employed to measure structural and material characteristics (e.g., material composition, dimensional characteristics of structures and films, etc.) associated with different semiconductor fabrication processes.

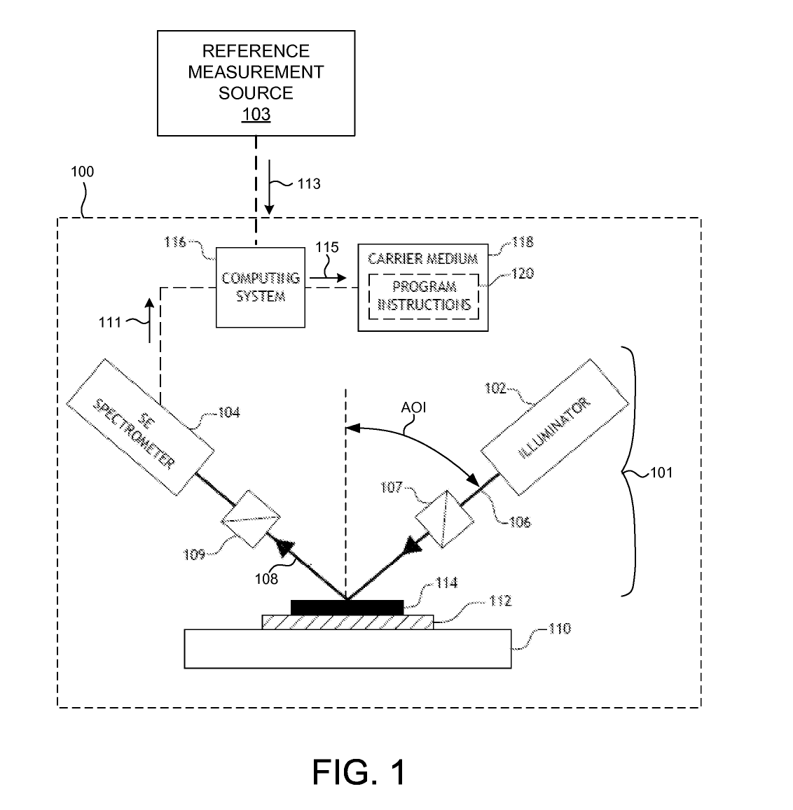

FIG. 1 illustrates a system 100 for measuring characteristics of a semiconductor wafer in accordance with the exemplary methods presented herein. As shown in FIG. 1, the system 100 may be used to perform spectroscopic ellipsometry measurements of one or more structures 114 of a semiconductor wafer 112 disposed on a wafer positioning system 110. In this aspect, the system 100 may include a spectroscopic ellipsometer equipped with an illuminator 102 and a spectrometer 104. The illuminator 102 of the system 100 is configured to generate and direct illumination of a selected wavelength range (e.g., 150-850 nm) to the structure 114 disposed on the surface of the semiconductor wafer 112. In turn, the spectrometer 104 is configured to receive illumination reflected from the surface of the semiconductor wafer 112. It is further noted that the light emerging from the illuminator 102 is polarized using a polarization state generator 107 to produce a polarized illumination beam 106. The radiation reflected by the structure 114 disposed on the wafer 112 is passed through a polarization state analyzer 109 and to the spectrometer 104. The radiation received by the spectrometer 104 in the collection beam 108 is analyzed with regard to polarization state, allowing for spectral analysis by the spectrometer of radiation passed by the analyzer. These spectra 111 are passed to the computing system 116 for analysis of the structure 114.

In a further embodiment, the metrology system 100 is a target measurement system 100 that may include one or more computing systems 116 employed to perform calibration of the machine parameter values of the target measurement system 100 in accordance with the methods described herein. The one or more computing systems 116 may be communicatively coupled to the spectrometer 104. In one aspect, the one or more computing systems 116 are configured to receive measurement data 111 associated with a critical dimension measurement of the structure 114 of specimen 112. In one example, the measurement data 111 includes an indication of the measured spectral response of the specimen by target measurement system 100 based on the one or more sampling processes from the spectrometer 104.

In addition, in some embodiments, the one or more computing systems 116 are further configured to receive a set of parameter values associated with a critical dimension measurement of the structure 114 by a reference measurement source 103. In some examples, the set of parameter values is stored in carrier medium 118 and retrieved by computing system 116.

The one or more computer systems are further configured to determine a value of at least one machine parameter value associated with the target measurement system 100 such that critical dimension measurements of specimen 112 by target measurement system 100 are matched to critical dimension measurements of specimen 112 by reference measurement source 103 within 0.1 percent of the critical dimension being measured.

In a further embodiment, the one or more computing systems 116 are configured to access model parameters in real-time, employing Real Time Critical Dimensioning (RTCD), or it may access libraries of pre-computed models for determining a value of at least one machine parameter value associated with the target measurement system 100 in accordance with the methods described herein. In summary, some form of CD-engine may be used to evaluate the difference between assigned CD parameters of a specimen and CD parameters for the same specimen as returned by a target measurement system for a given set of machine calibration parameters associated with the target system.

It should be recognized that the various steps described throughout the present disclosure may be carried out by a single computer system 116 or, alternatively, a multiple computer system 116. Moreover, different subsystems of the system 100, such as the spectroscopic ellipsometer 101, may include a computer system suitable for carrying out at least a portion of the steps described herein. Therefore, the aforementioned description should not be interpreted as a limitation on the present invention but merely an illustration. Further, the one or more computing systems 116 may be configured to perform any other step(s) of any of the method embodiments described herein.

In addition, the computer system 116 may be communicatively coupled to the spectrometer 104 or the illuminator subsystem 102 of the ellipsometer 101 in any manner known in the art. For example, the one or more computing systems 116 may be coupled to a computing system of the spectrometer 104 of the ellipsometer 101 and a computing system of the illuminator subsystem 102. In another example, the spectrometer 104 and the illuminator 102 may be controlled by a single computer system. In this manner, the computer system 116 of the system 100 may be coupled to a single ellipsometer computer system.

The computer system 116 of the system 100 may be configured to receive and/or acquire data or information from the subsystems of the system (e.g., spectrometer 104, illuminator 102, and the like) by a transmission medium that may include wireline and/or wireless portions. In this manner, the transmission medium may serve as a data link between the computer system 116 and other subsystems of the system 100. Further, the computing system 116 may be configured to receive measurement data via a storage medium (i.e., memory). For instance, the spectral results obtained using a spectrometer of ellipsometer 101 may be stored in a permanent or semi-permanent memory device (not shown). In this regard, the spectral results may be imported from an external system.

Moreover, the computer system 116 may send data to external systems via a transmission medium. Moreover, the computer system 116 of the system 100 may be configured to receive and/or acquire data or information from other systems (e.g., inspection results from an inspection system or metrology results from a metrology system) by a transmission medium that may include wireline and/or wireless portions. In this manner, the transmission medium may serve as a data link between the computer system 116 and other subsystems of the system 100. Moreover, the computer system 116 may send data to external systems via a transmission medium.

The computing system 116 may include, but is not limited to, a personal computer system, mainframe computer system, workstation, image computer, parallel processor, or any other device known in the art. In general, the term “computing system” may be broadly defined to encompass any device having one or more processors, which execute instructions from a memory medium.

Program instructions 120 implementing methods such as those described herein may be transmitted over or stored on carrier medium 118. The carrier medium may be a transmission medium such as a wire, cable, or wireless transmission link. The carrier medium may also include a computer-readable medium such as a read-only memory, a random access memory, a magnetic or optical disk, or a magnetic tape.

The embodiments of the system 100 illustrated in FIG. 1 may be further configured as described herein. In addition, the system 100 may be configured to perform any other block(s) of any of the method embodiment(s) described herein.

As illustrated in FIG. 1, a beam of broadband radiation from illuminator 102 is linearly polarized in polarization state generator 107, and the linearly polarized beam is then incident on specimen 112. After reflection from specimen 112, the beam propagates toward polarization state analyzer 109 with a changed polarization state. In some examples, the reflected beam has elliptical polarization. The reflected beam propagates through polarization state analyzer 109 into spectrometer 104. In spectrometer 104, the beam components having different wavelengths are refracted (e.g., in a prism spectrometer) or diffracted (e.g., in a grating spectrometer) in different directions to different detectors. The detectors may be a linear array of photodiodes, with each photodiode measuring radiation in a different wavelength range.

In one example, computing system 116 receives the measured data from each detector, and is programmed with software for processing the data it receives in an appropriate manner. The measured spectral response of a specimen may be determined by analyzing the changes in polarization of radiation reflected from the sample in response to incident radiation having known polarization state in any number of ways known in the art.

Any of polarization state generator 107 and polarization state analyzer 109 may be configured to rotate about their optical axis during a measurement operation. In some examples, computing system 116 is programmed to generate control signals to control the angular orientation of polarization state generator 107 and/or polarization state analyzer 109, or other elements of the system 100 (e.g., wafer positioning system 110 upon which specimen 112 rests). Computing system 116 may also receive data indicative of the angular orientation of polarization state analyzer 109 from an analyzer position sensor associated with polarization state analyzer 109. Similarly, computing system 116 may also receive data indicative of the angular orientation of polarization state generator 107 from a polarizer position sensor associated with polarization state generator 107. Computing system 116 may be programmed with software for processing such orientation data in an appropriate manner.

In one embodiment, the polarization state generator 107 is a linear polarizer that is controlled so that it rotates at a constant speed, and the polarization state analyzer is a linear polarizer that is not rotating (“the analyzer”). The signal received at each detector of spectrometer 104 will be a time-varying intensity given by:

I(t)=I₀[1+α cos(2ωt−P₀)+β sin(2ωt−P₀)] (1)

where I₀ is a constant that depends on the intensity of radiation emitted by illuminator 102, ω is the angular velocity of polarization state generator 107, P₀ is the angle between the optical axis of polarization state generator 107 and the plane of incidence (e.g., the plane of FIG. 1) at an initial time (t=0), and α and β are values defined as follows:

α=[tan²Ψ−tan²(A−A₀)]/[tan²Ψ+tan²(A−A₀)] (2)

and

β=[2(tan Ψ)(cos Δ)(tan(A−A₀))]/[tan²Ψ+tan²(A−A₀)] (3)

where tan(Ψ) is the amplitude of the complex ratio of the p and s reflection coefficients of the sample and Δ is the phase of the complex ratio of the p and s reflection coefficients of the sample. The “p” component denotes the component of polarized radiation whose electrical field is in the plane of FIG. 1, and “s” denotes the component of polarized radiation whose electrical field is perpendicular to the plane of FIG. 1. A is the nominal analyzer angle (e.g., a measured value of the orientation angle supplied, for example, from the above-mentioned analyzer position sensor associated with polarization state analyzer 109). A₀ is the offset of the actual orientation angle of polarization state analyzer 109 from the reading “A” (e.g., due to mechanical misalignment, A₀ may be non-zero).

From equations (1)-(3), values of α and β may be determined based on a measurement of a particular specimen by inspection system 100. Hence, for a particular specimen, values αₘₑₐₛ and βₘₑₐₛ are determined based on spectrometer data.

In general, ellipsometry is an indirect method of measuring physical properties of the specimen under inspection. In most cases, the measured values (e.g., αₘₑₐₛ and βₘₑₐₛ) cannot be used to directly determine the physical properties of the specimen. The nominal measurement process consists of parameterization of the structure (e.g., film thicknesses, critical dimensions, etc.) and the machine (e.g., wavelengths, angles of incidence, polarization angles, etc.). A model is created that attempts to predict the measured values (e.g., αₘₑₐₛ and βₘₑₐₛ). As illustrated in equations (4) and (5), the model includes parameters associated with the machine (P_{machine}) and the specimen (P_{specimen}).

α_{model}=f(P_{machine},P_{specimen}) (4)

β_{model}=g(P_{machine},P_{specimen}) (5)

Machine parameters are parameters used to characterize the inspection tool (e.g., ellipsometer 101). Exemplary machine parameters include angle of incidence (AOI), analyzer angle (A₀), polarizer angle (P₀), illumination wavelength, numerical aperture (NA), etc. Specimen parameters are parameters used to characterize the specimen (e.g., specimen 112 including structures 114). For a thin film specimen, exemplary specimen parameters include refractive index, dielectric function tensor, nominal layer thickness of all layers, layer sequence, etc. For measurement purposes, the machine parameters are treated as known, fixed parameters and the specimen parameters are treated as unknown, floating parameters. The floating parameters are resolved by an iterative process (e.g., regression) that produces the best fit between theoretical predictions and experimental data. The unknown specimen parameters, P_{specimen} are varied and the model output values (e.g., α_{model} and β_{model}) are calculated until a set of specimen parameter values are determined that results in a close match between the model output values and the experimentally measured values (e.g., αₘₑₐₛ and βₘₑₐₛ).

In a model based measurement application such as spectroscopic ellipsometry on a CD specimen, a regression process (e.g., ordinary least squares regression) is employed to identify specimen parameter values that minimize the differences between the model output values and the experimentally measured values for a fixed set of machine parameter values. Measurement consistency across multiple critical dimension applications and across multiple tools depends on properly calibrated sets of machine parameter values for each measurement system.

As discussed hereinbefore, an established machine parameter calibration technique for spectroscopic ellipsometers is based on measuring film-wafers with known film parameters (e.g., of known thickness and dielectric function) and employing a regression process to identify machine parameter values that minimize the differences between the model output values and the experimentally measured values for a fixed, known set of film parameter values. This technique performs well for film-wafer measurements. However, when a measurement system calibrated in this manner is used to measure critical dimension applications, matching performance across multiple tools is approximately one percent of the CD parameter values being measured. This performance is worse than what one would expect for a film measurement application and far worse than the critical dimension measurement repeatability of modern spectroscopic ellipsometer systems.

The inventors have discovered that matching performance across multiple CD measurement applications and multiple measurement systems is strongly dependent on the calibration of the tool. Moreover, film-only calibration tends to generate a combination of calibration parameters that does not reflect a CD sample as seen by the system. One way to understand this deficiency is by noting that some machine parameters do not impact the measurement results of a film-only measurement application, but have a substantial impact on the measurement results of a CD measurement application. Hence, the calibration of these particular machine parameters based on film-only measurement data is poor. The grating azimuth angle is one example of a machine parameter that has very little impact on film-only measurements, yet has a substantial impact on CD measurements. Calibration of grating azimuth angle based on film-only measurement data results in a poorly calibrated grating azimuth angle that manifests itself as inconsistent CD measurements across multiple CD measurement applications and across multiple tools. Other examples include the polarizer azimuth angle in a rotating compensator system arranged in a Polarizer-Sample-Compensator-Analyzer (PSCA) system with the polarizer azimuth at nominally +/−45 degrees to the plane of incidence, and the analyzer azimuth angle in a Polarizer-Compensator-Sample-Analyzer (PCSA) system with the analyzer azimuth at nominally +/−45 degrees to the plane of incidence.

In one aspect, machine parameter values of a metrology system are calibrated based on critical dimension measurement data such that critical dimension measurements performed by the calibrated metrology system are within less than 1% of assigned critical dimension values across multiple critical dimension measurement applications. In one further aspect, machine parameter values of the metrology system are calibrated based on critical dimension measurement data such that critical dimension measurements performed by the calibrated metrology system are within less than 1% of critical dimension values across multiple measurement applications and across multiple measurement systems. By way of non-limiting example, calibration of machine parameter values based on critical dimension data may be employed to enhance tool-to-tool matching among systems for measurement of critical dimensions (CD), film thickness, film composition, and overlay.

In some embodiments, critical dimension measurements performed by the calibrated metrology system are within less than 0.5% of critical dimension values across multiple measurement applications and across multiple measurement systems. In some embodiments, critical dimension measurements performed by the calibrated metrology system are within less than 0.1% of critical dimension values across multiple measurement applications and across multiple measurement systems.

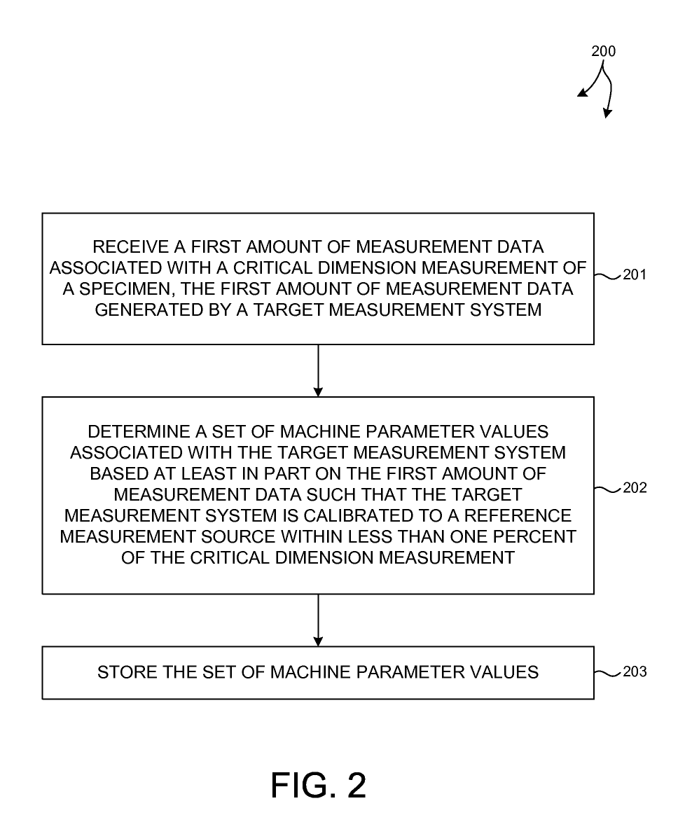

FIG. 2 illustrates a method 200 suitable for implementation by the metrology system 100 of the present invention. In one aspect, it is recognized that data processing blocks of method 200 may be carried out via a pre-programmed algorithm executed by one or more processors of computing system 116. While the following description is presented in the context of inspection system 100, it is recognized herein that the particular structural aspects of inspection system 100 do not represent limitations and should be interpreted as illustrative only.

In block 201, a first amount of measurement data 111 associated with a critical dimension measurement of structure 114 is received by computing system 116 from a target measurement system (e.g., ellipsometer 101). In some examples, the measurement data 111 is spectral data collected from spectrometer 104. In some other examples, the measurement data 111 has already undergone data processing by spectrometer 104. In one example, the indications of the measured spectral response are αₘₑₐₛ and βₘₑₐₛ values derived from measurement data by methods known in the art as discussed hereinbefore with reference to equations (1)-(3). In other examples, other indications of the measured spectral response may be contemplated (e.g., tan Ψ and Δ, etc.). The aforementioned examples of measurement data 111 are provided as non-limiting examples. Many other forms of measurement data within the context of ellipsometry or other measurement technologies may be contemplated.

The spectrometer 104 may transmit results associated with a spectroscopic measurement of the thin films of the wafer to one or more computing systems 116 for analysis. In another example, the measurement data 111 associated with a measurement of structure 114 may be acquired by importing previously obtained measurement data. In this regard, there is no requirement that the spectral acquisition and the subsequent analysis of the spectral data need be contemporaneous or performed in spatial proximity. For instance, measurement data may be stored in memory for analysis at a later time. In another instance, measurement results may be obtained and transmitted to a computing system located at a remote location for analysis in accordance with the methods described herein.

In block 202, computing system 116 determines a set of machine parameter values associated with the target measurement system based at least in part on the amount of measurement data 111 such that the target measurement system is calibrated to a reference measurement source within less than one percent of each value of each critical dimension measurement application.

In some examples, the calibration of machine parameter values of the target measurement system is based on CD measurement data from one or more measurement systems without knowledge of critical dimension parameter values. This may be advantageous when first establishing CD parameter values for targets that have not been adequately characterized by another measurement system.

In one example, the target measurement system is also the reference measurement source as the CD measurement data is collected from a single system to be calibrated. In this example, measurement data 111 includes multiple specimens 112. These specimens may be different locations on the same wafer, or locations on different wafers. A single specimen is associated with a single data set and a single model. The model includes one or more CD parameters, P_{specimen}. Some subset, or possibly all, of the CD parameters are important for matching and will be called CD applications, P_{App}. A model may be used for more than one specimen. Different models may be used for different specimens. Computing system 116 performs a regression routine where both the machine parameter values and the CD parameter values are floated. The regression routine attempts to find a set of machine parameter values, P_{machine}, that minimizes the difference between the CD measurement data and modeled results across the given set of specimens. Equation (6) illustrates an exemplary cost function that includes a summation of the residual error between the CD measurement data, D_{CD}, and modeled results, M_{CD}, over the wavelengths of illumination light, λ, the Fourier coefficients, F_{C}, (e.g., α and β), and each specimen.

$${χ}_{CD}^{2} = {\sum }_{specimen} {\sum }_{Fc} {\sum }_{λ} {( {D}_{CD} - {M}_{CD} ( \{ {P}_{machine ,} {P}_{specimen} \} ) )}^{2} \qquad ( 6 )$$

In general, elements of data D_{CD} and model M_{CD} may be weighted. In some examples, the weights are assigned as a function of any of the wavelengths of illumination light, λ, the Fourier coefficients, F_{C}, (e.g., α and β), the specimen, and the intensity from which the Fourier coefficients were calculated.

For measurement technologies other than rotating element ellipsometry, the sum over F_{C} may be a sum over angle of incidence at the specimen, as for angle resolved reflectometry, or a sum over discrete polarization states of the beams incident on and/or collected from the specimen, as for polarized reflectometry, or may not be present, as for unpolarized reflectometry. In some forms of rotating element ellipsometry an additional summation may be present. For example, an additional summation over angle of incidence at the specimen for multi-wavelength angle-resolved rotating element ellipsometry. The sums listed may occur in various combinations depending on the measurement technology. A summation may be over a single value. For example, the summation over wavelength would be a single term for single wavelength angle-resolved reflectometry. In general, the sums over λ and F_{C} are sums over any portion of the data set provided by the measurement technology for a specific specimen.

In some other examples, the CD measurement data is collected from multiple measurement systems based on measurements of the same specimens by each of the measurement systems. Hence, the reference measurement source includes a fleet of measurement systems. In this example, computing system 116 receives measurement data 111 and measurement data 113 from the reference measurement source 103. Computing system 116 performs a regression routine where both the machine parameter values and the CD parameter values are floated. The regression routine attempts to find a set of machine calibration parameters for each measurement system in the fleet that minimizes a weighted cost function illustrated by Equation (7). The weighted cost function of Equation (7) includes both the difference between CD measurement results and modeled results for a given set of applications as illustrated in Equation (6) and the variance of the CD parameter values across the fleet of measurement systems, weighted by factors A and B, respectively.

$${χ}_{tot}^{2} = A {\sum }_{specimen} {\sum }_{Fc} {\sum }_{λ} {( {D}_{CD} - {M}_{CD} ( \{ {P}_{machine ,} {P}_{specimen} \} ) )}^{2} + B {\sum }_{App} {{σ}_{App} [ {P}_{App} - 〈 {P}_{App} 〉 ]}^{2} \qquad ( 7 )$$

There are different approaches to defining the weighting function σ for a given cost function. However, one approach that was shown to be useful is to define the weights for an individual CD-parameter of a given CD-application as the inverse of a matching tolerance for said parameter.

$$σ = \frac{CD}{Δ CD} , \qquad ( 8 )$$

where σ is a weight for a given CD parameter, and ΔCD is the matching tolerance for that CD parameter. Any given CD application may contain multiple critical dimensions parameters. Further, as shown by way of example in equation (11), a matching requirement could include one or several CD applications. The index CD then addresses a specific CD parameter of a specific CD application, with a summation carried out over the range of CD parameters for all applications. As illustrated in equation (7), P_{App}, represents the parameter from a single specimen. In some other examples, it may instead be an average over a number of specimens (e.g., an average over sites on a single wafer).

In this manner, the minimization of the weighted cost function drives the residual errors between the measured data and modeled data toward zero and also drives the differences among CD parameter values toward zero. This ensures results that are consistent with the fact that the CD parameter values should be the same within the measurement repeatability of the fleet of measurement systems because the measurement data was collected by each system from the same structures.

In one further aspect, the calibration of the machine parameter values is based on CD measurement data and thin film measurement data collected by one or more measurement systems from one or more specimens without knowledge of critical dimension parameter values. In this manner machine parameters associated with thin film measurements are maintained and refined with the addition of CD measurement data, while additional machine parameters associated with CD measurements (e.g., grating azimuth angle) are calibrated. In these examples, the machine parameter values and the CD parameter values are floated in a regression on data from both film-wafers and CD-wafer together.

In one example, the target measurement system is also the reference measurement source as the CD measurement data is collected from a single system to be calibrated. In this example, measurement data 111 includes critical dimension measurement data of different CD measurement applications performed on structures of specimen 112 and also thin film measurement data associated with film structures of specimen 112 or another specimen. The thin film parameter values are known. In this example, computing system 116 receives measurement data 113 from measurement reference source 103 that includes the thin film parameter values. Computing system 116 performs a regression routine where the machine parameter values and the CD parameter values are floated for calculations based on the CD measurement data while the machine parameter values are floated for calculations based on the thin film measurement data. The regression routine attempts to minimize an aggregate cost function as illustrated in Equation (9). The aggregate cost function is a weighted sum of the CD cost function illustrated in Equation (6) and a thin film cost function illustrated in Equation (10). The thin film cost function attempts to find machine parameter values that minimize the difference between the thin film measurement data, D_{TF}, and modeled results, M_{TF}, across different thicknesses, t, Fourier coefficients, F_{C}, and illumination wavelengths, λ.

$$\begin{matrix}{χ}_{AGG}^{2} = A {χ}_{CD}^{2} + B {χ}_{TF}^{2} & ( 9 ) \\ {χ}_{TF}^{2} = {\sum }_{t} {\sum }_{Fc} {\sum }_{λ} {( {D}_{TF} - {M}_{TF} ( \{ {P}_{machine} \} , t ) )}^{2} & ( 10 )\end{matrix}$$

In some other examples, the CD measurement data and thin film measurement data are collected from multiple measurement systems for a particular specimen or set of specimens. Hence, the reference measurement source includes a fleet of measurement systems.

In this example, computing system 116 receives measurement data 111 from the target measurement system (e.g., ellipsometer 101) and measurement data 113 from the reference measurement source 103. Computing system 116 performs a regression routine where the machine parameter values and the CD parameter values are floated for calculations based on the CD measurement data while the machine parameter values are floated for calculations based on the thin film measurement data. The regression routine attempts to find a set of machine calibration parameters for each measurement system in the fleet that minimizes a weighted cost function illustrated by Equation (11). The cost function of Equation (11) includes the aggregate cost function of Equation (9) and the variance of the CD parameter values across the fleet of measurement systems, weighted by factors A and B, respectively.

$${χ}_{TOT}^{2} = A {χ}_{AGG}^{2} + B {\sum }_{App} {{σ}_{App} [ {P}_{App} - 〈 {P}_{App} 〉 ]}^{2} \qquad ( 11 )$$

In this manner, the minimization of the cost function drives residual errors between the measured data and modeled data for thin film and CD measurements toward zero and also minimizes the variance among CD application values.

In another further aspect, the calibration of the machine parameter values is based on critical dimension measurement data collected by a target measurement system from a specimen with assigned critical dimension parameter values.

The assigned critical dimension parameter values are received from a reference measurement source 103. In some examples, the reference measurement source 103 is a similar tool or group of similar tools. A similar tool may be a tool based on the same technology. For example, a similar tool could be the same model as the target measurement system. In some other examples, the reference measurement source is a tool based on a different technology (e.g., a scanning electron microscope or a tunneling electron microscope). In another example, the reference measurement source is a tool that supplies reference values at some time, and then at a later time becomes a target tool. This is an example of a self-matching scenario where it is desirable to match the current performance of a tool to its past performance (e.g., after a maintenance procedure, such as a light source change, etc.).

In some examples, the reference measurement source is a similar tool that is treated as a reference tool (or “golden” tool). Measurements from a “golden” tool are treated as the desired measurement output for a particular specimen. The objective is to calibrate the machine parameter values of the target measurement system such that the measurement output of the target measurement system matches the measurement output of the “golden” tool for the particular sample. In this manner, the target measurement system is “matched” with the “golden” tool. The calibration is repeated for other similar target measurement systems such that an entire fleet of similar measurement systems are “matched” to the “golden” tool.

In these examples, computing system 116 receives CD measurement data 111 from a target measurement system (e.g., ellipsometer 101) and measurement data 113 from measurement reference source 103 that includes the CD parameter values. Computing system 116 executes a regression routine where the machine parameter values are floated. The regression routine attempts to find a set of machine parameter values for the target measurement system that minimizes the difference between the CD measurement data and modeled results across a given set of CD measurement applications. Equation (12) illustrates an exemplary cost function that includes a summation of the residual error between the CD measurement data, D_{CD}, and modeled results, M_{CD}, over the wavelengths of illumination light, λ, the Fourier coefficients, F_{C}, (e.g., α and β), and each CD measurement application, App.

$${χ}_{CD}^{2} = {\sum }_{App} {\sum }_{Fc} {\sum }_{λ} {( {D}_{CD} - {M}_{CD} ( \{ {P}_{machine} \} ) )}^{2} \qquad ( 12 )$$

In some examples, the matching performance between a target measurement system and a reference measurement system has been improved by an order of magnitude using this calibration technique.

In some other examples, the reference measurement source is an average measurement output of a fleet of similar tools. The average measurement output of the fleet of tools for a particular sample is treated as the desired measurement output. The objective is calibrate the machine parameter values of the target measurement system such that the measurement output of the target measurement system matches the average measurement output of the fleet of tools. In this manner, the target measurement system is “matched” with the fleet average. The calibration is repeated for other similar target measurement systems such that each of the fleet of similar measurement systems is “matched” to the fleet average.

In these examples, computing system 116 receives CD measurement data 111 from a target measurement system (e.g., ellipsometer 101) and measurement data 113 from measurement reference source 103 that includes the average CD parameter values from multiple measurement systems. Computing system 116 executes a regression routine where the machine parameter values are floated. The regression routine attempts to find a set of machine parameter values for the target measurement system that minimizes the difference between the CD measurement data and modeled results across a given set of CD measurement applications. The cost function illustrated in Equation (12) is utilized with CD parameter values based on a fleet average rather than a “golden” tool.

In block 203, the set of machine parameter values determined in block 202 are stored in a carrier medium (e.g., carrier medium 118. In this manner, the set of calibrated machine parameter values are available for use by a target measurement system in future measurements.

For each of the aforementioned exemplary methods, a set of machine parameters is calibrated based at least in part on CD measurement data. The set of machine parameters associated with CD measurements may include all, some, or none of the set of machine parameters associated with thin film measurements. In a preferred embodiment, the machine parameters determined as part of a traditional thin film calibration are used to establish the starting values for the set of machine parameters associated with CD measurements. In this manner, the calibration calculations converge with less iteration because the machine parameter values established by thin film measurements are reasonably close to the final values after calibration based on CD measurements. By way of non-limiting example, machine parameters that may be refined based on calibration with CD measurement data include any of grating azimuth (angle between the plane of incidence and wafer grating vector), polarizer azimuth, analyzer azimuth, angle of incidence (AOI), wavelength dispersion, opening angles, etc.

As described hereinbefore, thin film specimen models and critical dimension specimen models are described as different models. However, in one example, a single specimen model may include both CD elements and thin film elements to describe, e.g., an optical response function for a particular optical metrology application. The methods described herein may be generally applied, and specifically to specimen models that include any combination of CD, thin film, and material composition elements.

In another aspect, one or more machine or CD parameter values may be isolated separately as part of another calibration or measurement process and treated as constants in the calibration methods described herein. For example, beam profile reflectometry (BPR) technology enables precise film thickness measurements. In some examples, film thickness is determined by a BPR system directly, and in subsequent regression calculations, the film thickness is treated as a fixed value. In another example, grating azimuth angle may be measured separately and treated as a fixed value in subsequent regression calculations. In yet another example, a set of calibration calculations is performed for a range of fixed grating azimuth angles. The calculation that delivers the best result determines the calibrated grating azimuth value.

The cost functions presented herein are provided by way of example. Many other cost functions may be employed to drive the regression of the machine parameter values. For example, the cost functions may be weighted in any suitable manner. In another example, the cost function may be the minimization of the maximum value of the difference between the CD measurement data and modeled results across a given set of CD measurement applications. Other examples may be contemplated based on methods of parameter fitting that are known in the art.

Although the methods discussed herein are explained with reference to system 100, any optical metrology system configured to illuminate and detect light reflected, transmitted, or diffracted from a specimen may be employed to implement the exemplary methods described herein. Exemplary systems include an angle-resolved reflectometer, a scatterometer, a reflectometer, an ellipsometer, a spectroscopic reflectometer or ellipsometer, a beam profile reflectometer, a multi-wavelength, two-dimensional beam profile reflectometer, a multi-wavelength, two-dimensional beam profile ellipsometer, a rotating compensator spectroscopic ellipsometer, etc. By way of non-limiting example, an ellipsometer may include a single rotating compensator, multiple rotating compensators, a rotating polarizer, a rotating analyzer, a modulating element, multiple modulating elements, or no modulating element.

It is noted that the output from a source and/or target measurement system may be set in such a way that the measurement system uses more than one technology. In fact, an application may be configured to employ any combination of available metrology sub-systems within a single tool, or across a number of different tools. In the case of a particular CD or thin-film application, a cost function minimization can be applied sequentially for one sub-system at a time, or it can be applied in parallel, where all sub-systems are represented in a cost-function. The advantages and disadvantages for a parallel vs. sequential optimization may be weighed against each other for a given application. For instance, one may choose a sequential mode, because it is overall faster, or one may use a parallel mode, because it returns an overall better matching result.

A system implementing the methods described herein may also be configured in a number of different ways. For example, a wide range of wavelengths (including visible, ultraviolet, infrared, and X-ray), angles of incidence, states of polarization, and states of coherence may be contemplated. In another example, the system may include any of a number of different light sources (e.g., a directly coupled light source, a laser-sustained plasma light source, etc.). In another example, the system may include elements to condition light directed to or collected from the specimen (e.g., apodizers, filters, etc.).

By way of non-limiting example, machine parameters that may be calibrated based on CD measurement data include: grating azimuth angle (i.e., the angle between the grating wavevector and a plane of incidence of the optical metrology system), polarizer azimuth angle, analyzer azimuth angle, first waveplate (compensator) azimuth angle, second waveplate (compensator) azimuth angle, first waveplate (compensator) retardation, second waveplate (compensator) retardation, illumination angle of incidence for any number of light sources (e.g., UV, VUV, DUV, IR, visible light sources), opening angle (i.e., numerical aperture) of a focused or small-spot optical metrology system, numerical aperture map versus pixel calibration parameters of a focused or small-spot optical metrology system, camera azimuth angle for a focused or small-spot optical metrology system, a wavelength calibration parameter, a phase term that describes the focusing optics, a spectrum of phase terms that describe the focusing optics over a range of wavelengths, a phase term that describes collection optics, a spectrum of phase terms that describe the collection optics over a range of wavelengths, pixel to wavelength mapping of a spectrometer, a parameter that represents polarization mixing, a parameter that represents polarization mixing over a range of wavelengths, a background correction over a range of wavelengths, a background correction for any given single wavelength, a scatter correction term over a range of wavelengths, a scatter correction term for any given single wavelength, a point spread function (PSF) calibration over a range of wavelengths, a point spread function (PSF) calibration for any given single wavelength, a polarizer leakage calibration over a range of wavelengths, a polarizer leakage calibration term for any given single wavelength, an objective polarization map over a range of wavelengths, an objective polarization map for any given single wavelength, an objective polarization rotation or ellipticity map over a range of wavelengths, an objective polarization rotation or ellipticity map for any given single wavelength, etc.

As discussed herein, calibration of machine parameter values based on CD measurement data significantly improves tool-to-tool matching for a given set of measurement applications. However, in addition, the methods described herein may also be used to determine whether it is possible for an optical metrology system to be matched. For example, a failure of the calibration calculations to converge may indicate that there are hardware issues, e.g., wafer load angle, or issues with CD transfer standards that need to be resolved before the machine is capable of being matched to another tool or fleet of tools. In another example, changes in machine calibration parameter values required for tool-to-tool matching may be used as an indicator of tool health. In another example, if the machine calibration parameters required to achieve tool-to-tool matching fall outside a range that is deemed acceptable, the result may be used to diagnose an underlying issue with measurement hardware, the specimen, or the model that is being used in the application. In another example, machine calibration based on previously measured data is much faster than making manual adjustments to the machine calibration parameters, and subsequently re-measuring the same transfer standards to reassess the impact of the modified calibration on tool-to-tool matching.

As discussed herein, calibration of machine parameter values based on CD measurement data significantly improves tool-to-tool matching for a given set of measurement applications. However, it has also been shown that calibration of machine parameter values based on thin film data significantly improves tool-to-tool matching across a set of thin film measurement applications using the same methods described herein. In these examples, the methods described herein are employed except critical dimension measurement data and critical dimension parameter values are replaced by thin film measurement data and thin film parameter values. Similarly, calibration of machine parameter values based on material composition data (e.g., n & k values) significantly improves tool-to-tool matching across a set of material composition measurement applications. In these examples, the methods described herein are employed except critical dimension measurement data and critical dimension parameter values are replaced by material composition data and material composition parameter values. In this manner, calibration of machine parameters based on thin film measurement data across different applications and calibration of machine parameters based on material composition measurement data in accordance with the methods described herein results in improved tool-to-tool matching performance.

As described herein, the term “critical dimension” includes any critical dimension of a structure (e.g., bottom critical dimension, middle critical dimension, top critical dimension, sidewall angle, grating height, etc.), a critical dimension between any two or more structures (e.g., distance between two structures), and a displacement between two or more structures (e.g., overlay displacement between overlaying grating structures, etc.). Structures may include three dimensional structures, patterned structures, overlay structures, etc.

As described herein, the term “critical dimension application” or “critical dimension measurement application” includes any critical dimension measurement.

As described herein, the term “metrology system” includes any system employed at least in part to characterize a specimen in any aspect. However, such terms of art do not limit the scope of the term “metrology system” as described herein. In addition, the metrology system 100 may be configured for measurement of patterned wafers and/or unpatterned wafers. The metrology system may be configured as a LED inspection tool, edge inspection tool, backside inspection tool, macro-inspection tool, or multi-mode inspection tool (involving data from one or more platforms simultaneously), and any other metrology or inspection tool that benefits from the calibration of system parameters based on critical dimension data.

Various embodiments are described herein for a semiconductor processing system (e.g., an inspection system or a lithography system) that may be used for processing a specimen. The term “specimen” is used herein to refer to a site on a wafer, a reticle, or any other sample that may be processed (e.g., printed or inspected for defects) by means known in the art.

As used herein, the term “wafer” generally refers to substrates formed of a semiconductor or non-semiconductor material. Examples include, but are not limited to, monocrystalline silicon, gallium arsenide, and indium phosphide. Such substrates may be commonly found and/or processed in semiconductor fabrication facilities. In some cases, a wafer may include only the substrate (i.e., bare wafer). Alternatively, a wafer may include one or more layers of different materials formed upon a substrate. One or more layers formed on a wafer may be “patterned” or “unpatterned.” For example, a wafer may include a plurality of dies having repeatable pattern features.

A “reticle” may be a reticle at any stage of a reticle fabrication process, or a completed reticle that may or may not be released for use in a semiconductor fabrication facility. A reticle, or a “mask,” is generally defined as a substantially transparent substrate having substantially opaque regions formed thereon and configured in a pattern. The substrate may include, for example, a glass material such as amorphous SiO₂. A reticle may be disposed above a resist-covered wafer during an exposure step of a lithography process such that the pattern on the reticle may be transferred to the resist.

One or more layers formed on a wafer may be patterned or unpatterned. For example, a wafer may include a plurality of dies, each having repeatable pattern features. Formation and processing of such layers of material may ultimately result in completed devices. Many different types of devices may be formed on a wafer, and the term wafer as used herein is intended to encompass a wafer on which any type of device known in the art is being fabricated.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. A method comprising:
receiving a first amount of measurement data associated with a critical dimension measurement of a specimen, the first amount of measurement data generated by a target measurement system;
determining a first set of machine parameter values associated with the target measurement system based at least in part on the first amount of measurement data such that the target measurement system is calibrated to a reference measurement source within less than one percent of the critical dimension measurement; and
storing the first set of machine parameter values.

2. The method of claim 1, wherein the critical dimension measurement includes any of a critical dimension of a structure, a critical dimension between two or more structures, and a displacement between two or more structures.

3. The method of claim 1, wherein the target measurement system is calibrated to the reference measurement source within less than 0.1 percent of the critical dimension measurement.

4. The method of claim 1, further comprising:
receiving a set of critical dimension parameter values associated with the specimen, the set of critical dimension parameter values generated by the reference measurement source, wherein the determining the first set of machine parameter values associated with the target measurement system is based at least in part on the first amount of measurement data and the set of critical dimension parameter values.

5. The method of claim 4, wherein the determining the first set of machine parameter values involves minimizing a cost function that includes a difference between the first amount of measurement data and a measurement model that includes the first set of machine parameter values of the target measurement system and the set of critical dimension parameter values.

6. The method of claim 4, wherein the reference measurement source and the target measurement system have substantially similar measurement repeatability.

7. The method of claim 4, wherein the reference measurement source is a reference measurement system of the same type as the target measurement system.

8. The method of claim 4, wherein the reference measurement source is a fleet of measurement systems of the same type as the target measurement system, and wherein each of the set of critical dimension parameter values is an average value of each of the set of critical dimension parameter values as measured by each of the fleet of measurement systems.

9. The method of claim 4, further comprising:
receiving a second amount of measurement data associated with a thin film measurement of a second specimen, the second amount of measurement data generated by the target measurement system;
receiving a set of thin film parameter values associated with the second specimen; and
determining a second set of machine parameter values associated with the target measurement system based at least in part on the second amount of measurement data and the set of thin film parameter values, wherein the first set of machine parameter values is a refinement of the second set of machine parameter values.

10. The method of claim 9, wherein the first set of machine parameter values includes a parameter that is not included in the second set of machine parameter values.

11. The method of claim 1, wherein the target measurement system is any of a beam profile reflectometer, an angle resolved reflectometer, a spectroscopic reflectometer, an ellipsometer, a beam profile ellipsometer, and a spectroscopic ellipsometer.

12. The method of claim 1, further comprising:
receiving a second amount of measurement data associated with a thin film measurement of a second specimen, the second amount of measurement data generated by the target measurement system, wherein the determining the first set of machine parameter values associated with the target measurement system is based at least in part on the first amount of measurement data and the second amount of measurement data.

13. The method of claim 12, wherein the determining the first set of machine parameter values associated with the target measurement system involves minimizing a cost function that includes a difference between the first amount of measurement data and a first measurement model that includes the first set of machine parameter values of the target measurement system and a set of critical dimension parameter values, and a difference between the second amount of measurement data and a second measurement model that includes a second set of machine parameter values of the target measurement system and a set of thin film parameter values.

14. A non-transitory, computer-readable medium, comprising:
code for causing a computer to receive a first amount of measurement data associated with a critical dimension measurement of a specimen, the first amount of measurement data generated by a target measurement system;
code for causing the computer to determine a first set of machine parameter values associated with the target measurement system based at least in part on the first amount of measurement data such that the target measurement system is calibrated to a reference measurement source within less than one percent of the critical dimension measurement; and
code for causing the computer to store the first set of machine parameter values.

15. The non-transitory, computer-readable medium of claim 14, further comprising:
code for causing the computer to receive a set of critical dimension parameter values associated with the specimen, the set of critical dimension parameter values generated by the reference measurement source, wherein the determining the set of machine parameter values associated with the target measurement system is based at least in part on the first amount of measurement data and the set of critical dimension parameter values.

16. The non-transitory, computer-readable medium of claim 14, further comprising:
code for causing the computer to receive a second amount of measurement data associated with a thin film measurement of a second specimen, the second amount of measurement data generated by the target measurement system, wherein the determining the first set of machine parameter values associated with the target measurement system is based at least in part on the first amount of measurement data and the second amount of measurement data.

17. An apparatus comprising:
an illumination source;
a detector; and
one or more computer systems configured to:
receive a first amount of measurement data associated with a critical dimension measurement of a specimen, the first amount of measurement data generated by a target measurement system;
determine a first set of machine parameter values associated with the target measurement system based at least in part on the first amount of measurement data such that the target measurement system is calibrated to a reference measurement source within less than one percent of the critical dimension measurement; and
store the first set of machine parameter values.

18. The apparatus of claim 17, wherein the target measurement system is calibrated to the reference measurement source within less than 0.1 percent of the critical dimension measurement.

19. The apparatus of claim 17, wherein the one or more computer systems is further configured to:
receive a set of critical dimension parameter values associated with the specimen, the set of critical dimension parameter values generated by the reference measurement source, wherein the determining the set of machine parameter values associated with the target measurement system is based at least in part on the first amount of measurement data and the set of critical dimension parameter values.

20. The apparatus of claim 17, wherein the one or more computer systems is further configured to:
receive a second amount of measurement data associated with a thin film measurement of a second specimen, the second amount of measurement data generated by the target measurement system, wherein the determining the first set of machine parameter values associated with the target measurement system is based at least in part on the first amount of measurement data and the second amount of measurement data.
